(19) United States
(12) Patent Application Publication
(10) Pub. No.: US 2010/0088366 A1
(43) Pub. Date: Apr. 8, 2010

(54) SYSTEM AND METHOD FOR TRANSMITTING FILES BETWEEN ELECTRONIC DEVICES

(75) Inventors: XIAO-GUANG LI, Shenzhen City (CN); LI-ZHANG HUANG, Tu-Cheng (TW); TE-YUAN KUNG, Tu-Cheng (TW); ZAI-AN PAN, Shenzhen City (CN); XIAO-FANG CHEN, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/425,402

(22) Filed: Apr. 17, 2009

(30) Foreign Application Priority Data
Oct. 8, 2008 (CN) 200810304784.1

(51) Int. Cl. G06F 15/16

(52) U.S. Cl. 709/203

(57) ABSTRACT

The present invention provides a system and method for transmitting files between electronic devices. The method includes: supplying a computer for connecting at least one electronic device to the computer and connecting the computer to a server; obtaining inputs from a user; obtaining identifier (ID) of a target electronic device and the files that are selected in the electronic device by a user, wherein the target electronic device is configured for providing space to store files; generating a request including the ID of the target electronic device; and sending the request and the files that are selected in the electronic device to the server.

### RELATED APPLICATIONS

This application is related to a co-pending U.S. patent application filed concurrently herewith whose Attorney Docket No is US16981 and entitled “SYSTEM AND METHOD FOR TRANSMITTING FILES BETWEEN ELECTRONIC DEVICES,” which is incorporated herein in its entirety by reference.

### BACKGROUND

1. Technical Field

The disclosure relates to an electronic device, a computer, a server and method for transmitting files between electronic devices via the computer and the server.

2. Description of the Related Art

Electronic devices like digital photo frames have many functions which not only includes displaying images but also communicating with other electronic devices. However, because of the limitation of their input keys, many digital photo frames cannot be manipulated as easily and quickly as those for a computer, especially when one digital photo frame is used to transmit images to another digital photo frame.

Accordingly, what is needed in the art is a system and method for transmitting files between electronic devices via the computer and the server.

### BRIEF DESCRIPTION OF THE DRAWINGS

The components in the drawings are not necessarily drawn to scale, the emphasis instead being placed upon clearly illustrating the principles of the system and the method for transmitting files between electronic devices. Moreover, in the drawings, like reference numerals designate corresponding parts throughout the several views.

FIG. 1 is a schematic diagram of a system for transmitting files between electronic devices which include a plurality of digital photo frames, a plurality of computers and one server, in accordance with an exemplary embodiment.

FIG. 2 is a block diagram of a hardware infrastructure of one of the digital photo frames in the system of FIG. 1, in accordance with an exemplary embodiment.

FIG. 3 is a block diagram of a hardware infrastructure of one of the computers in the system of FIG. 1, in accordance with an exemplary embodiment.

FIG. 4 is a block diagram of a hardware infrastructure of the server in the system of FIG. 1, in accordance with an exemplary embodiment.

FIG. 5 is a flowchart of transmitting files between the digital photo frames implemented by the computer of FIG. 3, in accordance with an exemplary embodiment.

FIG. 6 is a flowchart of transmitting files between digital photo frames implemented by the server of FIG. 4, in accordance with an exemplary embodiment.

### DETAILED DESCRIPTION

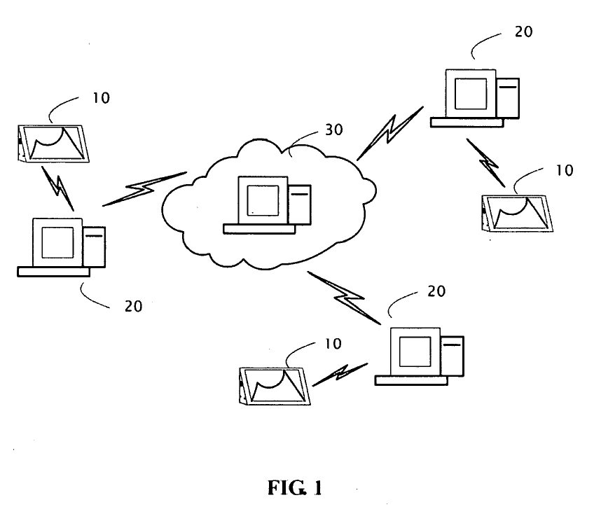

FIG. 1 is a schematic diagram of a hardware infrastructure of a system for transmitting files between electronic devices (hereinafter, “the system”) in accordance with an exemplary embodiment. The system includes a plurality of electronic devices 10, a plurality of computers 20, and a server 30. Each of the computers 20 is connected with a corresponding electronic device 10, and the server 30 is connected with all the computers 20. The connections between the computers 20 and the electronic devices 10, as well as the connections between the server 30 and the computers 20, can be made by hardwire, wireless, or a combination of both.

The electronic devices 10 may be digital photo frames, cameras, and so on. Taking the digital photo frame as the electronic devices 10 for example in the present disclosure, the digital photo frames 10 can be hardwired to the computer 20, through, for example a Universal Serial Bus (USB) or connection, or wirelessly connected, for example, through a wireless LAN connection. The computers 20 may be connected to the server 30 via a wireless network, cable and so on over the Internet. Each of the digital photo frames 10 has the same hardware infrastructure, but with a unique identifier (ID). Each of the digital photo frames 10 can log onto the server 30 via the corresponding computer 20. The server 30 records the ID of the digital photo frame 10 when the digital photo frame 10 logs onto the server 30, and regards the digital photo frame 10 as being in an online state. The server 30 further regards the digital photo frame 10 as being in an offline state when the digital photo frame 10 logs off the server 30.

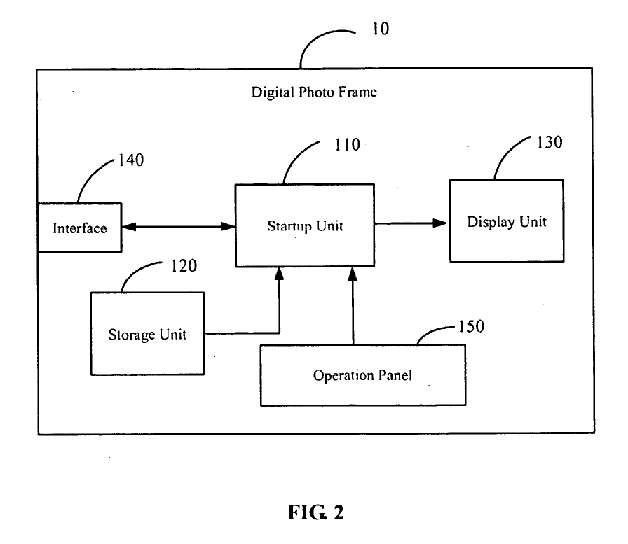

FIG. 2 is a schematic diagram of a hardware infrastructure of the digital photo frame 10 of FIG. 1, in accordance with an exemplary embodiment. The digital photo frame 10 includes a startup unit 110, a storage unit 120, a display unit 130, an interface 140, and an operation panel 150. The storage unit 120 is configured for storing a preset table and a program. The preset table records a plurality of IDs of the digital photo frames 10. When the startup unit 110 is activated, the digital photo frame 10 sends a startup signal to the computer 20 connected therewith to install the program on the computer 20. The display unit 130 is configured for displaying files. The interface 140 is configured for connecting with an external device (e.g., the computer 20). The operation panel 150 is configured with a plurality of user input units for receiving the user inputs.

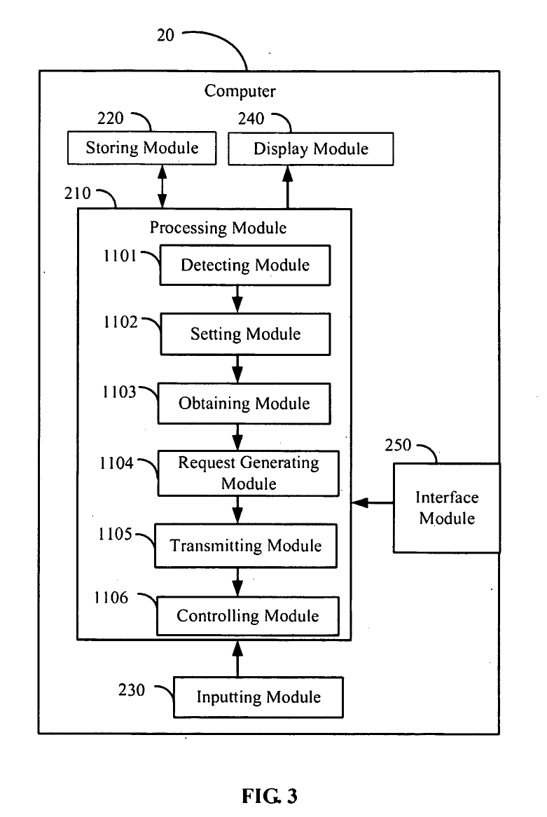

FIG. 3 is a schematic diagram of a hardware infrastructure of the computer 20 of FIG. 1, in accordance with an exemplary embodiment. The computer 20 includes a processing module 210, a storing module 220, an inputting module 230, a display module 240, and an interface module 250. The storing module 220 is configured for storing files. The display module 240 is configured for displaying files. The interface module 250 is configured for connecting the digital photo frame 10 to the computer 20 and connecting the computer 20 to the server 30.

When the startup unit 110 of the digital photo frame is activated, the computer 20 obtains the program from the storage unit 120, and starts the program to execute the processing module 210. In another embodiment, the processing module 210 maybe preinstalled on the storage unit 120, not be installed from the digital photo frame. In the present disclosure, take the digital photo frame 10 that supplies files to other digital photo frames as a source digital photo frame, and the digital photo frame 10 that receives files from other digital photo frames as a target digital photo frame for example in the following disclosure. The source digital photo frame stores files and IDs of other digital photo frames, and transmits files to any one or more of the other digital photo frames. The target digital photo frame has space available to store files from the source digital photo frame. When a user wants to send files from the source digital photo frame to the target digital photo frame, the user can input instructions to activate the source digital photo frame. The inputting module 230 obtains inputs from the user and changes the input into corresponding signals. The processing module 210 obtains the ID of the target digital photo frame and files that the user selects from the source digital photo frame, generates a request including the ID of the target digital photo frame, and sends the request and the files to the server 30.

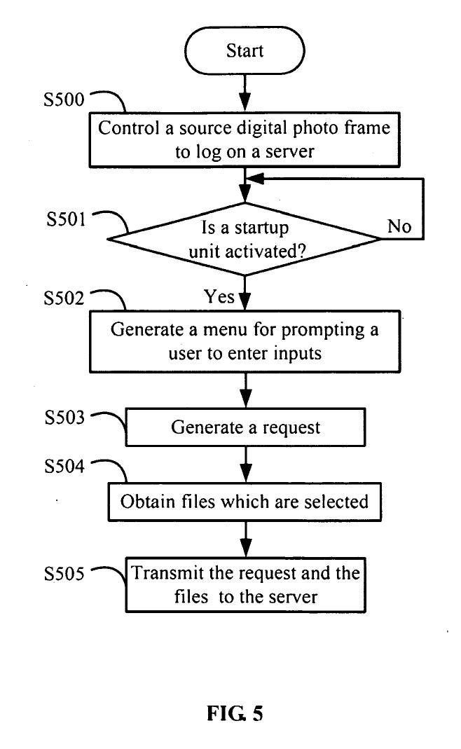

The processing module 210 includes a detecting module 1101, a setting module 1102, an obtaining module 1103, a request generating module 1104, a transmitting module 1105, and a controlling module 1106. The controlling module 1106 is configured for recognizing the ID of the source digital photo frame, and controlling the source digital photo frame to log on or off the server 30. The other modules of the processing module 210 are described together with FIG. 5.

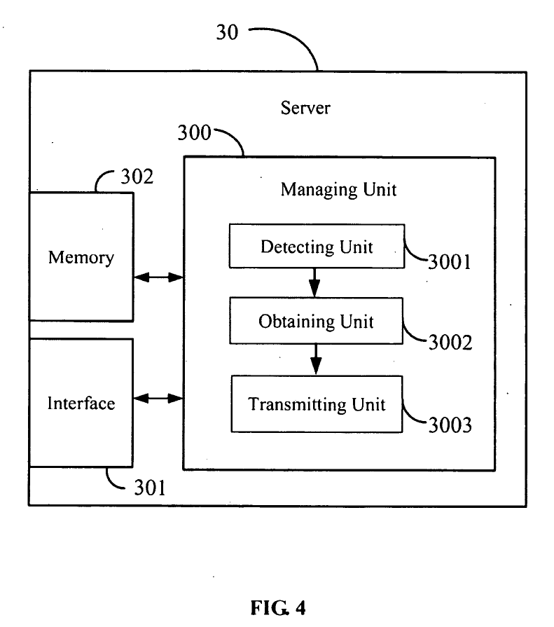

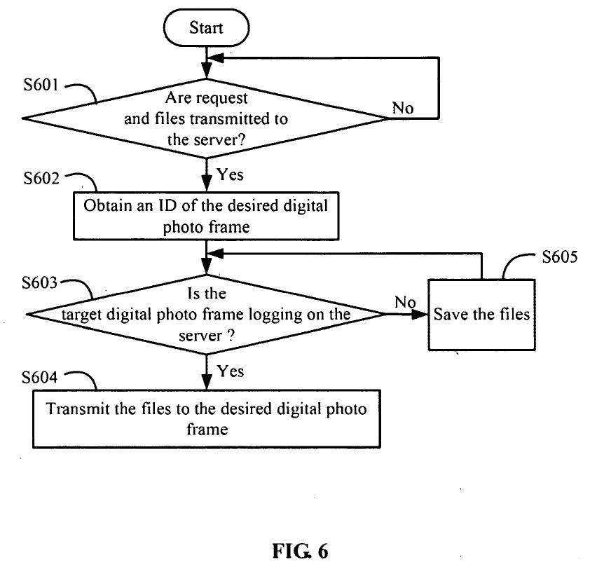

FIG. 4 is a block diagram of a hardware infrastructure of the server 30 of FIG. 1, in accordance with an exemplary embodiment. The server 30 includes a managing unit 300, an interface 301, and a memory 302. The interface 301 is configured for connecting the computers 20. The memory 302 is configured for storing data. The managing unit 300 further includes a detecting unit 3001, an obtaining unit 3002, and a transmitting unit 3003. The managing unit 300 is described together with FIG. 6.

FIG. 5 is a flowchart of transmitting files between the digital photo frames 10 implemented by the computer 20 in accordance with an exemplary embodiment. In step S500, when the source digital photo frame is connected to the computer 20, the controlling module 1106 recognizes the ID of the source digital photo frame, and controls the source digital photo frame to log onto the server 30 via the computer 20.

In step S501, the detecting module 1101 detects if the startup signal is transmitted to the computer 20 to determine the startup unit 110 is activated.

In step S502, if the detecting module 1101 detects the startup unit 110 is activated, the setting module 1102 generates a menu for prompting the user to enter inputs. The menu may include a plurality of IDs of the digital photo frames 10, and all the files in the source digital photo frame.

In step S503, the obtaining module 1103 obtains the ID of the target digital photo frame according to the inputs of the user, and the request generating module 1104 generates the request including the ID of the target digital photo frame.

In step S504, the obtaining module 1103 obtains the files which are selected from the source digital photo frame by the user.

In step S505, the transmitting module 1105 transmits the request and the files that the user selects to the server 30.

FIG. 6 is a flowchart of transmitting files between digital photo frames 10 implemented by the server 30, in accordance with an exemplary embodiment. In step S601, the detecting unit 3001 detects if the request and the files that the user selects are transmitted to the server 30 via the interface 301 of the server 30.

In step S602, if the detecting unit 3001 detects the request and the files that the user selects are transmitted to the server 30, the obtaining unit 3002 obtains the file that the user selects, and obtain the ID of the target digital photo frame from the request.

In step S603, the detecting unit 3001 determines if the target digital photo frame logs on the server 30 according to the ID of the target digital photo frame.

In step S604, if the detecting unit 3001 determines the target digital photo frame having logged onto the server 30, the transmitting unit 3003 transmitted the files that the user selects to the target digital photo frame.

In step S605, if the detecting unit 3001 determines the target digital photo frame having not logged onto the server 30, the transmitting unit 3003 stores the files that the user selects. When the target digital photo frame logs onto the server 30, the transmitting unit 3003 transmits the files that the user selects to the target digital photo frame.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A computer for transmitting files between electronic devices, comprising:
a storing module for storing files;
a display module for displaying the files;
an interface module configured for connecting an electronic device to the computer and connecting the computer to a server;
an inputting module configured for obtaining inputs from a user; and
a processing unit configured for obtaining an identifier (ID) of a target electronic device and the files that are selected in the electronic device by a user, generating a request including the ID of the target electronic device, and sending the request and the files that are selected in the electronic device to the server; wherein the target electronic device is configured for providing space to store files.

2. The computer as recited in claim 1, wherein the processing unit is further configured for controlling the electronic device to log on or off the server when the electronic device is connected with the computer.

3. The computer as recited in claim 2, wherein the processing unit is further configured for generating a menu for prompting inputs from the user when a startup signal is received.

4. The computer as recited in claim 3, wherein the menu includes a plurality of IDs of the electronic devices, and the files in the source electronic device.

5. The computer as recited in claim 1, wherein the electronic device is a digital photo frame, and the target electronic device is a digital photo frame.

6. A method for transmitting files between electronic devices, comprising;
supplying a computer for connecting at least one electronic device to the computer and connecting the computer to a server;
obtaining inputs from a user;
obtaining an identifier (ID) of a target electronic device and the files that are selected in the electronic device by a user, wherein the target electronic device is configured for providing space to store files;
generating a request including the ID of the target electronic device; and
sending the request and the files that are selected in the electronic device to the server.

7. The method as recited in claim 6, further comprising:
the computer controlling the electronic device to log on or off the server when the electronic device is connected with the computer.

8. The method as recited in claim 6, further comprising:
the computer generating a menu for prompting inputs from the user when a startup signal is received.

9. The method as recited in claim 8, further comprising:
the computer obtaining inputs from the user according to the menu.

10. A server for transmitting files between electronic devices, comprising:
an obtaining unit is configured for obtaining a request and files that a user selects from a source electronic device via an interface of the server, wherein the request including an identifier (ID) of a target electronic device, the source electronic device is configured for supplying files for the user selecting, the target electronic device is configured for providing space to store files;
a detecting unit is configured for determining if the target electronic device logs on the server according to the ID of the target electronic device; and
a transmitting unit is configured for transmitting the obtained files to the target electronic device if the detecting unit determines the target electronic device having logged onto the server.

11. The server as recited in claim 10, wherein the transmitting unit is further configured for storing the files that the user selects if the detecting unit determines the target electronic device having not logged onto the server.

12. The server as recited in claim 10, further comprising:
a storing module for storing files;
a display module for displaying the files;
an inputting module configured for obtaining inputs from a user; and
a processing unit configured for obtaining identifier (ID) of the target electronic device and the files that the user selects, and generating the request including the ID of the target electronic device.

13. The server as recited in claim 12, wherein the processing unit is further configured for controlling the electronic device to log on or off the server.

14. The server as recited in claim 12, wherein the processing unit is further configured for generating a menu for prompting inputs from the user when a startup signal is received.

15. The server as recited in claim 14, wherein the menu includes a plurality of IDs of the electronic devices, and the files in the source electronic device.
